(19) United States
(12) Patent Application Publication
(10) Pub. No.: US 2020/0292825 A1
(43) Pub. Date: Sep. 17, 2020

(54) ATTENTION DIRECTION ON OPTICAL PASSTHROUGH DISPLAYS

(71) Applicant: Apple Inc., Cupertino, CA (US)

(72) Inventors: Anselm Grundhoefer, Saratoga, CA (US); Devin William Chalmers, Oakland, CA (US)

(21) Appl. No.: 16/818,250

(22) Filed: Mar. 13, 2020

Related U.S. Application Data
(60) Provisional application No. 62/818,840, filed on Mar. 15, 2019.

(51) Int. Cl. G02B 27/01; G06T 11/00

(52) U.S. Cl. CPC G02B 27/0172; G06T 11/001; G02B 2027/0187; G02B 2027/0138; G02B 2027/014; G02B 27/0179

(57) ABSTRACT

In one implementation, a method of directing a user's attention is performed by a device including one or more processors, non-transitory memory, a scene camera and an optical passthrough display. The method includes capturing, using the scene camera, an image of a scene. The method includes determining, using the one or more processors, one or more attention-indirection regions based on the image of the scene. The method includes displaying, on the optical see-through display, a masking image including a masking pattern in the one or more attention-indirection regions.

### CROSS-REFERENCE TO RELATED APPLICATIONS

This application claims priority to U.S. Provisional Patent App. No. 62/818,840, filed on Mar. 15, 2019, which is hereby incorporated by reference in its entirety.

### TECHNICAL FIELD

The present disclosure generally relates to computer-generated reality environments and, in particular, to systems, methods, and devices for directing a user's attention in a computer-generated reality environment.

### BACKGROUND

As described herein, in order to provide immersive media experiences to a user, computing devices present computer-generated reality (CGR) that intertwines computer-generated media content (e.g., including images, video, audio, smells, haptics, etc.) with real-world stimuli to varying degrees—ranging from wholly synthetic experiences to barely perceptible computer-generated media content superimposed on real-world stimuli. To these ends, in accordance with various implementations described herein, CGR systems, methods, and devices include mixed reality (MR) and virtual reality (VR) systems, methods, and devices. Further, MR systems, methods, and devices include augmented reality (AR) systems in which computer-generated content is superimposed (e.g., via a transparent display) upon the field-of-view of the user and composited reality (CR) systems in which computer-generated content is composited or merged with an image of the real-world environment. While the present description provides delineations between AR, CR, MR, and VR for the mere sake of clarity, those of ordinary skill in the art will appreciate from the present disclosure that such delineations are neither absolute nor limiting with respect to the implementation of any particular CGR system, method, and/or device. Thus, in various implementations, a CGR environment include elements from a suitable combination of AR, CR, MR, and VR in order to produce any number of desired immersive media experiences.

In various implementations, a user is present in a CGR environment, either physically or represented by an avatar (which may be virtual or real, e.g., a drone or robotic avatar). In various implementations, the avatar simulates some or all of the physical movements of the user.

A CGR environment based on VR may be wholly immersive to the extent that real-world sensory inputs of particular senses of the user (e.g., vision and/or hearing) are completely replaced with computer-generated sensory inputs. Accordingly, the user is unable to see and/or hear his/her real-world surroundings. CGR environments based on VR can utilize (spatial) audio, haptics, etc. in addition to computer-generated images to enhance the realism of the experience. Thus, in various implementations, real-world information of particular senses provided to the user is limited to depth, shape, orientation, and/or layout information; and such real-world information is passed indirectly to the user. For example, the walls of real-world room are completely skinned with digital content so that the user cannot see the real-world walls as they exist in reality.

A CGR environment based on mixed reality (MR) includes, in addition to computer-generated media content, real-world stimuli received by a user either directly, as in the case of a CGR environment based on augmented reality (AR), or indirectly, as in the case of a CGR environment based on composited reality (CR).

A CGR environment based on augmented reality (AR) includes real-world optical passthrough such that real-world light enters a user's eyes. For example, in an AR system a user is able to see the real world through a transparent surface, and computer-generated media content (e.g., images and/or video) is visualized onto that surface. In particular implementations, the media content is visualized onto the surface to give the visual impression that the computer-generated media content is a part of and/or anchored to the real-world. Additionally or alternatively, the computer-generated image data may be projected directly towards a user's eyes so that real-world light and the projected light of the computer-generated media content concurrently arrive on a user's retinas.

A CGR environment based on composited reality (CR) includes obtaining real-world stimulus data obtained from an appropriate sensor and compositing the real-world stimulus data with computer-generated media content (e.g., merging the stimulus data with the computer-generated content, superimposing the computer-generated content over portions of the stimulus data, or otherwise altering the real-world stimulus data before presenting it to the user) to generated composited data. The composited data is then provided to the user, and thus the user receives the real-world stimulus indirectly, if at all. For example, for visual portions of a GGR environment based on CR, real-world image data is obtained using an image sensor, and the composited image data is provided via a display.

In various implementations, it may be desirable to direct the attention of a user in a CGR environment to an object or area of the CGR environment or away from an object or area of the CGR environment. In various implementations, the attention of a user is directed by displaying visual masking structures, such as noise, in areas of the CGR environment where attention of the user is not to be directed.

### BRIEF DESCRIPTION OF THE DRAWINGS

So that the present disclosure can be understood by those of ordinary skill in the art, a more detailed description may be had by reference to aspects of some illustrative implementations, some of which are shown in the accompanying drawings.

FIG. 1A is a block diagram of an example operating architecture in accordance with some implementations.

FIG. 1B is a perspective view of a CGR environment in accordance with some implementations.

FIG. 2 is a block diagram of an example controller in accordance with some implementations.

FIG. 3A is a block diagram of an example head-mounted device (HMD) in accordance with some implementations.

FIG. 3B is a blow-up view of an example CGR display in accordance with some implementations.

FIG. 4A illustrates a real environment in accordance with some implementations.

FIG. 4B-4E illustrate CGR environments based on the real environment of FIG. 4A directing a user's attention in accordance with some implementations.

FIG. 5 is a flowchart representation of a method of directing a user's attention in accordance with some implementations.

In accordance with common practice the various features illustrated in the drawings may not be drawn to scale. Accordingly, the dimensions of the various features may be arbitrarily expanded or reduced for clarity. In addition, some of the drawings may not depict all of the components of a given system, method or device. Finally, like reference numerals may be used to denote like features throughout the specification and figures.

### SUMMARY

Various implementations disclosed herein include devices, systems, and methods for directing a user's attention. In various implementations, a method is performed by a device including one or more processors, non-transitory memory, a scene camera and an optical passthrough display. The method includes capturing, using the scene camera, an image of a scene. The method includes determining, using the one or more processors, one or more attention-indirection regions based on the image of the scene. The method includes displaying, on the optical see-through display, a masking image including a masking pattern in the one or more attention-indirection regions.

In accordance with some implementations, a device includes one or more processors, a non-transitory memory, and one or more programs; the one or more programs are stored in the non-transitory memory and configured to be executed by the one or more processors. The one or more programs include instructions for performing or causing performance of any of the methods described herein. In accordance with some implementations, a non-transitory computer readable storage medium has stored therein instructions, which, when executed by one or more processors of a device, cause the device to perform or cause performance of any of the methods described herein. In accordance with some implementations, a device includes: one or more processors, a non-transitory memory, and means for performing or causing performance of any of the methods described herein.

### DESCRIPTION

Numerous details are described in order to provide a thorough understanding of the example implementations shown in the drawings. However, the drawings merely show some example aspects of the present disclosure and are therefore not to be considered limiting. Those of ordinary skill in the art will appreciate that other effective aspects and/or variants do not include all of the specific details described herein. Moreover, well-known systems, methods, components, devices, and circuits have not been described in exhaustive detail so as not to obscure more pertinent aspects of the example implementations described herein.

In various implementations, it may be desirable to direct the attention of a user in a CGR environment to an object or area of the CGR environment. For example, a game executed by an HMD presenting the CGR environment may desire to direct the user's attention to a game objective. As another example, a map application executed by the HMD may desire to direct the user's attention to a map destination. In various other implementations, it may be desirable to direct the attention of a user away from an object or area of the CGR environment, such as an advertisement or inappropriate context. In various implementations, the attention of a user is directed by displaying noise in areas of the CGR environment where attention of the user is not to be directed.

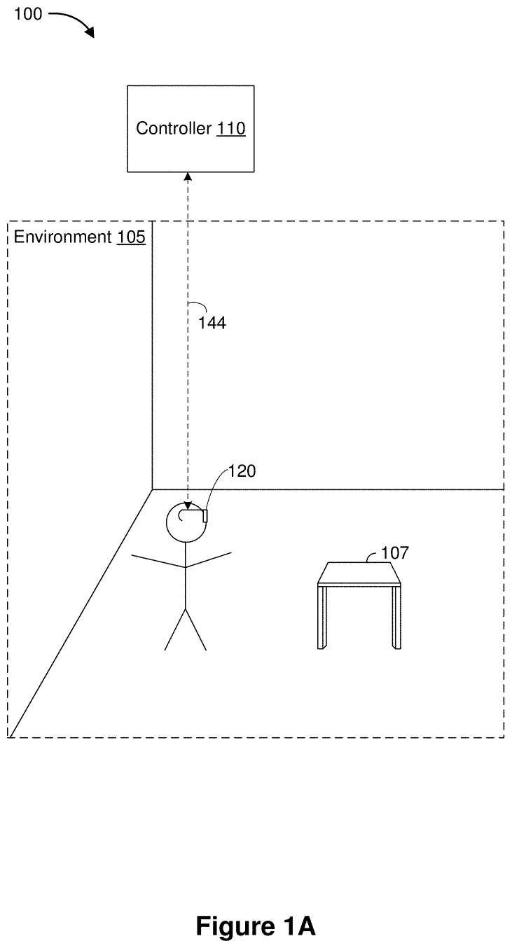

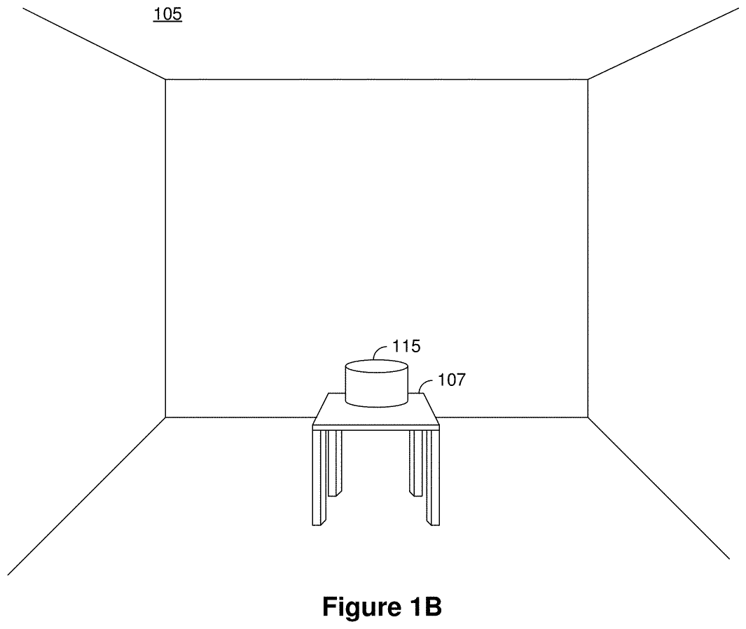

FIG. 1A is a block diagram of an example operating architecture 100 in accordance with some implementations. While pertinent features are shown, those of ordinary skill in the art will appreciate from the present disclosure that various other features have not been illustrated for the sake of brevity and so as not to obscure more pertinent aspects of the example implementations disclosed herein. To that end, as a non-limiting example, the operating architecture 100 includes a controller 110 and a head-mounted device (HMD) 120 within a real environment 105 including a table 107.

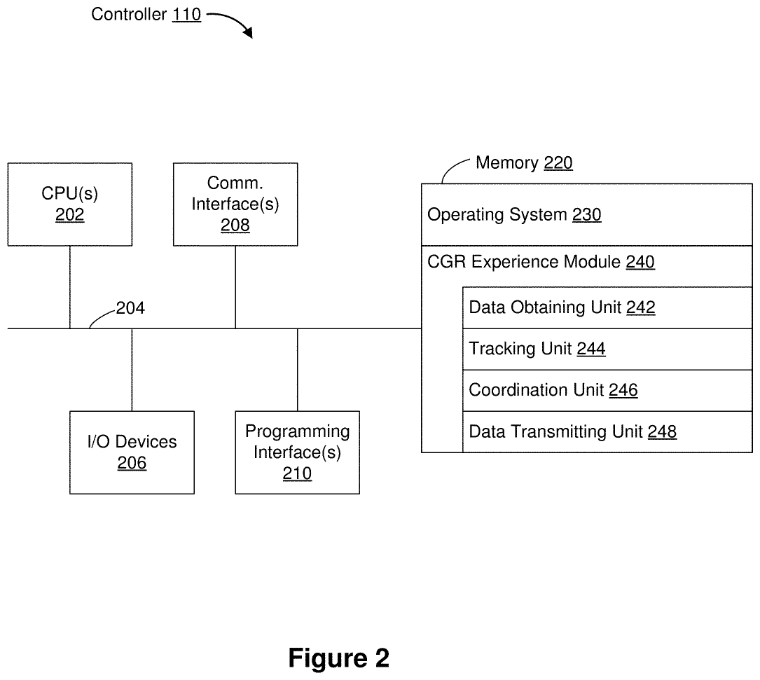

In some implementations, the controller 110 is configured to manage and coordinate a CGR experience for the user. In some implementations, the controller 110 includes a suitable combination of software, firmware, and/or hardware. The controller 110 is described in greater detail below with respect to FIG. 2. In some implementations, the controller 110 is a computing device that is local or remote relative to the environment 105. For example, the controller 110 is a local server located within the environment 105. In another example, the controller 110 is a remote server located outside of the environment 105 (e.g., a cloud server, central server, etc.). In some implementations, the controller 110 is communicatively coupled with the HMD 120 via one or more wired or wireless communication channels 144 (e.g., BLUETOOTH, IEEE 802.11x, IEEE 802.16x, IEEE 802.3x, etc.). In another example, the controller 110 is included within the enclosure of the HMD 120.

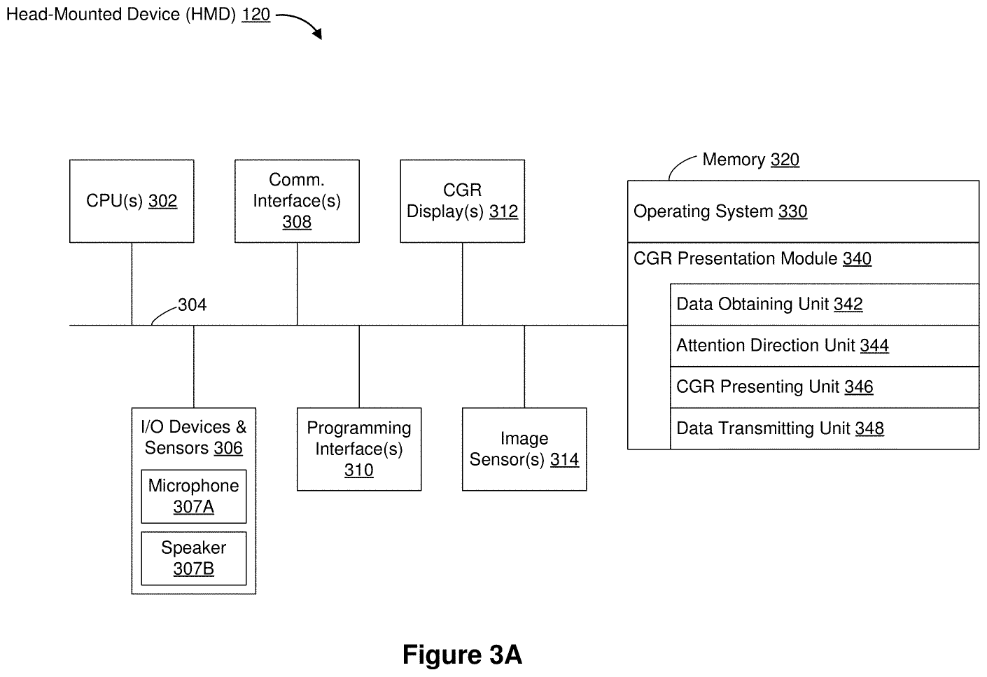

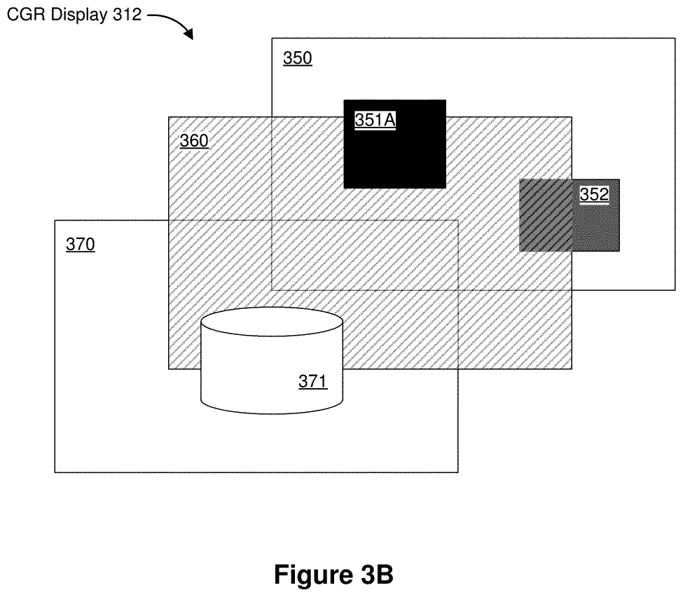

According to some implementations, the HMD 120 provides a CGR experience to the user while the user is virtually and/or physically present within the environment 105. For example, FIG. 1B illustrates the environment 105 from the perspective of the user in which the table 107 is visible with a virtual object 115 (displayed by the HMD 120) upon the table 107. In some implementations, the HMD 120 includes a suitable combination of software, firmware, and/or hardware. The HMD 120 is described in greater detail below with respect to FIG. 3A. In some implementations, the functionalities of the controller 110 are provided by and/or combined with the HMD 120.

In some implementations, the user wears the HMD 120 on his/her head. As such, the HMD 120 includes one or more CGR displays provided to display the CGR content. For example, in various implementations, the HMD 120 encloses the field-of-view of the user. In some implementations, the HMD 120 is replaced with a handheld device (such as a smartphone or tablet) configured to present CGR content, and rather than wearing the HMD 120 the user holds the device with a display directed towards the field-of-view of the user and a camera directed towards the environment 105. In some implementations, the handheld device can be placed within an enclosure that can be worn on the head of the user. In some implementations, the HMD 120 is replaced with a CGR chamber, enclosure, or room configured to present CGR content in which the user does not wear or hold the HMD 120.

FIG. 2 is a block diagram of an example of the controller 110 in accordance with some implementations. While certain specific features are illustrated, those skilled in the art will appreciate from the present disclosure that various other features have not been illustrated for the sake of brevity, and so as not to obscure more pertinent aspects of the implementations disclosed herein. To that end, as a non-limiting example, in some implementations the controller 110 includes one or more processing units 202 (e.g., microprocessors, application-specific integrated-circuits (ASICs), field-programmable gate arrays (FPGAs), graphics processing units (GPUs), central processing units (CPUs), processing cores, and/or the like), one or more input/output (I/O) devices 206, one or more communication interfaces 208 (e.g., universal serial bus (USB), FIREWIRE, THUNDERBOLT, IEEE 802.3x, IEEE 802.11x, IEEE 802.16x, global system for mobile communications (GSM), code division multiple access (CDMA), time division multiple access (TDMA), global positioning system (GPS), infrared (IR), BLUETOOTH, ZIGBEE, and/or the like type interface), one or more programming (e.g., I/O) interfaces 210, a memory 220, and one or more communication buses 204 for interconnecting these and various other components.

In some implementations, the one or more communication buses 204 include circuitry that interconnects and controls communications between system components. In some implementations, the one or more I/O devices 206 include at least one of a keyboard, a mouse, a touchpad, a joystick, one or more microphones, one or more speakers, one or more image sensors, one or more displays, and/or the like.

The memory 220 includes high-speed random-access memory, such as dynamic random-access memory (DRAM), static random-access memory (SRAM), double-data-rate random-access memory (DDR RAM), or other random-access solid-state memory devices. In some implementations, the memory 220 includes non-volatile memory, such as one or more magnetic disk storage devices, optical disk storage devices, flash memory devices, or other non-volatile solid-state storage devices. The memory 220 optionally includes one or more storage devices remotely located from the one or more processing units 202. The memory 220 comprises a non-transitory computer readable storage medium. In some implementations, the memory 220 or the non-transitory computer readable storage medium of the memory 220 stores the following programs, modules and data structures, or a subset thereof including an optional operating system 230 and a CGR experience module 240.

The operating system 230 includes procedures for handling various basic system services and for performing hardware dependent tasks. In some implementations, the CGR experience module 240 is configured to manage and coordinate one or more CGR experiences for one or more users (e.g., a single CGR experience for one or more users, or multiple CGR experiences for respective groups of one or more users). To that end, in various implementations, the CGR experience module 240 includes a data obtaining unit 242, a tracking unit 244, a coordination unit 246, and a data transmitting unit 248.

In some implementations, the data obtaining unit 242 is configured to obtain data (e.g., presentation data, interaction data, sensor data, location data, etc.) from at least the HMD 120 of FIG. 1A. To that end, in various implementations, the data obtaining unit 242 includes instructions and/or logic therefor, and heuristics and metadata therefor.

In some implementations, the tracking unit 244 is configured to map the scene (e.g., the environment 105) and to track the position/location of at least the HMD 120 with respect to the scene (e.g., the environment 105 of FIG. 1A). To that end, in various implementations, the tracking unit 244 includes instructions and/or logic therefor, and heuristics and metadata therefor.

In some implementations, the coordination unit 246 is configured to manage and coordinate the CGR experience presented to the user by the HMD 120A. To that end, in various implementations, the coordination unit 246 includes instructions and/or logic therefor, and heuristics and metadata therefor.

In some implementations, the data transmitting unit 248 is configured to transmit data (e.g., presentation data, location data, etc.) to at least the HMD 120A. To that end, in various implementations, the data transmitting unit 248 includes instructions and/or logic therefor, and heuristics and metadata therefor.

Although the data obtaining unit 242, the tracking unit 244, the coordination unit 246, and the data transmitting unit 248 are shown as residing on a single device (e.g., the controller 110), it should be understood that in other implementations, any combination of the data obtaining unit 242, the tracking unit 244, the coordination unit 246, and the data transmitting unit 248 may be located in separate computing devices.

Moreover, FIG. 2 is intended more as functional description of the various features that may be present in a particular implementation as opposed to a structural schematic of the implementations described herein. As recognized by those of ordinary skill in the art, items shown separately could be combined and some items could be separated. For example, some functional modules shown separately in FIG. 2 could be implemented in a single module and the various functions of single functional blocks could be implemented by one or more functional blocks in various implementations. The actual number of modules and the division of particular functions and how features are allocated among them will vary from one implementation to another and, in some implementations, depends in part on the particular combination of hardware, software, and/or firmware chosen for a particular implementation.

FIG. 3A is a block diagram of an example of the HMD 120 in accordance with some implementations. While certain specific features are illustrated, those skilled in the art will appreciate from the present disclosure that various other features have not been illustrated for the sake of brevity, and so as not to obscure more pertinent aspects of the implementations disclosed herein. To that end, as a non-limiting example, in some implementations the HMD 120 includes one or more processing units 302 (e.g., microprocessors, ASICs, FPGAs, GPUs, CPUs, processing cores, and/or the like), one or more input/output (I/O) devices and sensors 306, one or more communication interfaces 308 (e.g., USB, FIREWIRE, THUNDERBOLT, IEEE 802.3x, IEEE 802.11x, IEEE 802.16x, GSM, CDMA, TDMA, GPS, IR, BLUETOOTH, ZIGBEE, and/or the like type interface), one or more programming (e.g., I/O) interfaces 310, one or more CGR displays 312, one or more optional interior- and/or exterior-facing image sensors 314, a memory 320, and one or more communication buses 304 for interconnecting these and various other components.

In some implementations, the one or more communication buses 304 include circuitry that interconnects and controls communications between system components. In some implementations, the one or more I/O devices and sensors 306 include at least one of an inertial measurement unit (IMU), an accelerometer, a gyroscope, a thermometer, one or more physiological sensors (e.g., blood pressure monitor, heart rate monitor, blood oxygen sensor, blood glucose sensor, etc.), one or more microphones 307A, one or more speakers 307B, a haptics engine, one or more depth sensors (e.g., a structured light, a time-of-flight, or the like), and/or the like.

In some implementations, the one or more CGR displays 312 are configured to provide the CGR experience to the user. In some implementations, the one or more CGR displays 312 correspond to holographic, digital light processing (DLP), liquid-crystal display (LCD), liquid-crystal on silicon (LCoS), organic light-emitting field-effect transitory (OLET), organic light-emitting diode (OLED), surface-conduction electron-emitter display (SED), field-emission display (FED), quantum-dot light-emitting diode (QD-LED), micro-electro-mechanical system (MEMS), and/or the like display types. In some implementations, the one or more CGR displays 312 correspond to diffractive, reflective, polarized, holographic, etc. waveguide displays. For example, the HMD 120 includes a single CGR display. In another example, the HMD 120 includes a CGR display for each eye of the user. In some implementations, the one or more CGR displays 312 are capable of presenting MR and VR content.

In various implementations, the one or more CGR displays 312 are video passthrough displays which display at least a portion of the environment 105 as an image captured by a scene camera. In various implementations, the one or more CGR displays 312 are optical passthrough displays which are at least partially transparent and pass light emitted by or reflected off the environment 105. FIG. 3B illustrates a blow-up view of an optical passthrough CGR display 312 in accordance with some implementations. In various implementations, the CGR display 312 includes a selectively occlusive layer 350 that includes a number of pixel elements that, when activated, block light from passing through the optical passthrough display 312. Thus, through appropriate addressing of the selectively occlusive layer 350, the CGR display can render a black region 351A or a gray region 352. In various implementations, the CGR display 312 includes a globally dimmable layer 360 that, according to a controllable dimming level, dims lights passing through the optical passthrough display 312. In various implementations, the CGR display 312 includes a light addition layer 370 that includes a number of pixel elements that, when activated, emit light towards the user. Thus, through appropriate addressing of the light addition layer 370, the CGR display 312 can render a white (or colored) virtual object 371. In various implementations, the CGR display does not include each of the layers 350, 360, 370. In particular, in various implementations, the CGR display does not include the selectively occlusive layer 350 and/or the globally dimmable layer 360. In various implementations, the CGR display 312 does not include the light addition layer 370 and/or the globally dimmable layer 360. In various implementations, the CGR display does not include the selectively occlusive layer 350 and/or the light addition layer 370.

In some implementations, the one or more image sensors 314 are configured to obtain image data that corresponds to at least a portion of the face of the user that includes the eyes of the user (any may be referred to as an eye-tracking camera). In some implementations, the one or more image sensors 314 are configured to be forward-facing so as to obtain image data that corresponds to the scene as would be viewed by the user if the HMD 120 was not present (and may be referred to as a scene camera). The one or more optional image sensors 314 can include one or more RGB cameras (e.g., with a complimentary metal-oxide-semiconductor (CMOS) image sensor or a charge-coupled device (CCD) image sensor), one or more infrared (IR) cameras, one or more event-based cameras, and/or the like.

The memory 320 includes high-speed random-access memory, such as DRAM, SRAM, DDR RAM, or other random-access solid-state memory devices. In some implementations, the memory 320 includes non-volatile memory, such as one or more magnetic disk storage devices, optical disk storage devices, flash memory devices, or other non-volatile solid-state storage devices. The memory 320 optionally includes one or more storage devices remotely located from the one or more processing units 302. The memory 320 comprises a non-transitory computer readable storage medium. In some implementations, the memory 320 or the non-transitory computer readable storage medium of the memory 320 stores the following programs, modules and data structures, or a subset thereof including an optional operating system 330 and a CGR presentation module 340.

The operating system 330 includes procedures for handling various basic system services and for performing hardware dependent tasks. In some implementations, the CGR presentation module 340 is configured to present CGR content to the user via the one or more CGR displays 312. To that end, in various implementations, the CGR presentation module 340 includes a data obtaining unit 342, an attention direction unit 344, a CGR presentation unit 346, and a data transmitting unit 348.

In some implementations, the data obtaining unit 342 is configured to obtain data (e.g., presentation data, interaction data, sensor data, location data, etc.) from at least the controller 110 of FIG. 1A. To that end, in various implementations, the data obtaining unit 342 includes instructions and/or logic therefor, and heuristics and metadata therefor.

In some implementations, the attention direction unit 344 is configured to direct a user's attention in a CGR environment. To that end, in various implementations, the attention direction unit 344 includes instructions and/or logic therefor, and heuristics and metadata therefor.

In some implementations, the CGR presenting unit 346 is configured to present CGR content via the one or more CGR displays 312. To that end, in various implementations, the CGR presenting unit 346 includes instructions and/or logic therefor, and heuristics and metadata therefor.

In some implementations, the data transmitting unit 348 is configured to transmit data (e.g., presentation data, location data, etc.) to at least the controller 110. To that end, in various implementations, the data transmitting unit 348 includes instructions and/or logic therefor, and heuristics and metadata therefor.

Although the data obtaining unit 342, the attention direction unit 344, the CGR presenting unit 346, and the data transmitting unit 348 are shown as residing on a single device (e.g., the HMD 120 of FIG. 1A), it should be understood that in other implementations, any combination of the data obtaining unit 342, the attention direction unit 344, the CGR presenting unit 346, and the data transmitting unit 348 may be located in separate computing devices.

Moreover, FIG. 3A is intended more as a functional description of the various features that could be present in a particular implementation as opposed to a structural schematic of the implementations described herein. As recognized by those of ordinary skill in the art, items shown separately could be combined and some items could be separated. For example, some functional modules shown separately in FIG. 3A could be implemented in a single module and the various functions of single functional blocks could be implemented by one or more functional blocks in various implementations. The actual number of modules and the division of particular functions and how features are allocated among them will vary from one implementation to another and, in some implementations, depends in part on the particular combination of hardware, software, and/or firmware chosen for a particular implementation.

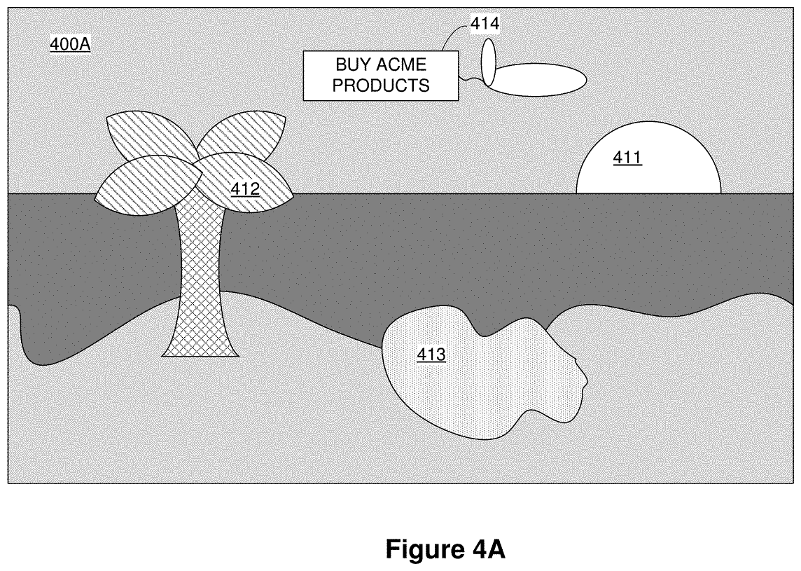

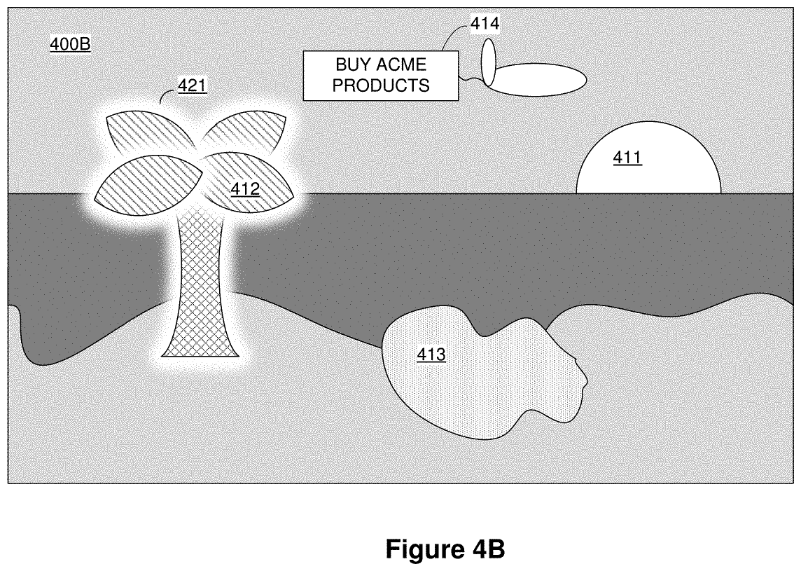

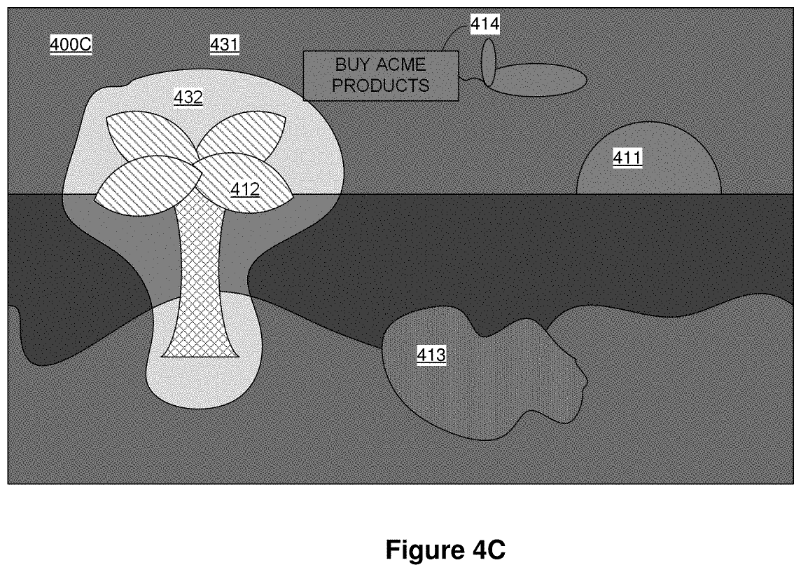

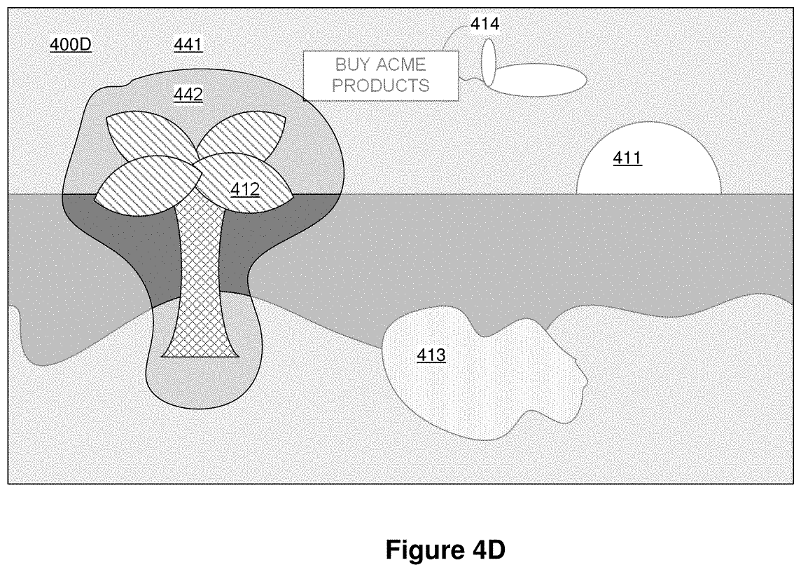

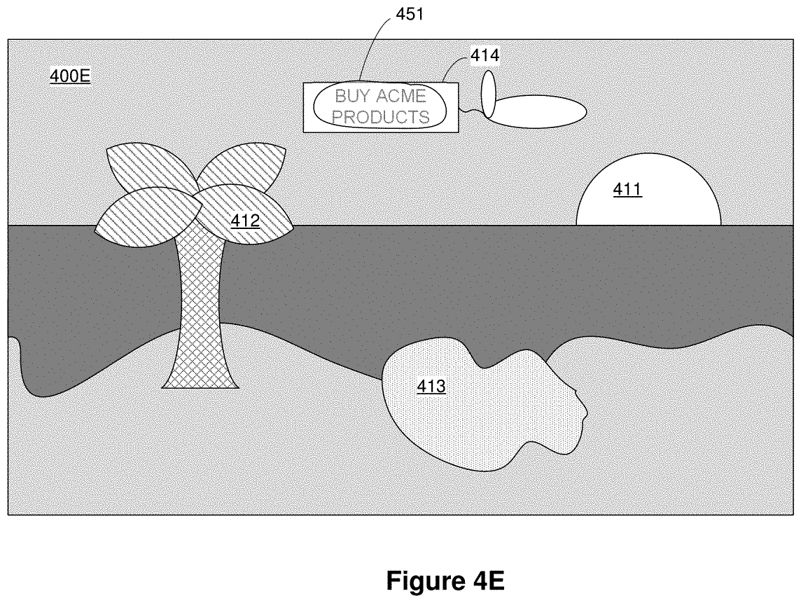

FIG. 4A illustrates a real environment 400A in accordance with some implementations. The real environment 400A includes a sun 411, a tree 412, a rock 413, and an aerial advertisement 414.

FIG. 4B illustrates a CGR environment 400B based on the real environment 400A of FIG. 4A. The CGR environment 400B includes the sun 411, the tree 412, the rock 413, and the aerial advertisement 414. In various implementations, in order to direct a user's attention to the tree 412, the CGR environment 400B includes a glowing outline 421 surrounding the tree 412.

In various implementations, the CGR environment 400B is generated by a video passthrough display that captures an image of the real environment 400A with a scene camera and presents the image of the real environment 400A with the glowing outline 421 overlaid on the image. In various implementations, the CGR environment 400B is generated by an optical passthrough display that passes light reflected off the real environment 400A while displaying an AR image including the glowing outline 421.

In various circumstances, it may be difficult to generate a glowing outline surrounding an object (or other edge enhancement or attention-directing effect). For example, detection of the edges of the object may be inaccurate. As another example, the edges of the object may move unpredictably within the time it take to capture an image of the object and render the glowing outline (e.g., the leaves on the tree 412 sway before the glowing outline is displayed over the tree 412). Further, mitigating such difficulties may be computationally expensive.

Accordingly, in various implementations, alternative mechanisms are used to direct the user's attention to an attention-direction region of a scene (or away from attention-indirection regions of a scene). In various implementations, the attention-direction region corresponds to an object or area of the scene that is of particular relevance, importance, or interest or any object or area to which a user's attention is to be directed. For example, the attention-direction region can correspond to a game objective, a map destination, or a safety issue. In various implementations, the attention-indirection region corresponds to an object or area of the scene that is irrelevant, unimportant, or offensive. For example, the attention-indirection region can correspond to an advertisement, inappropriate content, or proprietary content or any object or area away from which a user's attention is to be directed.

FIG. 4C illustrates a CGR environment 400C based on the real environment 400A of FIG. 4A. The CGR environment 400C includes the sun 411, the tree 412, the rock 413, and the aerial advertisement 414. In various implementations, in order to direct a user's attention to the tree 412, the CGR environment 400C includes an attention-direction region 432 including the tree 412 and an attention-indirection region 431 away from tree 412. In FIG. 4C, the attention-indirection region 431 is dimmed with respect to the real environment 400A.

In various implementations, the CGR environment 400C is generated by a video passthrough display that captures an image of the real environment 400A with a scene camera and presents the image of the real environment 400A with the attention-indirection region 431 dimmed.

In various implementations, the CGR environment 400C is generated by an optical passthrough display that passes light reflected off the real environment 400A while dimming the attention-indirection region 431. In various implementations, the attention-indirection region 431 is dimmed by selectively occluding the attention-indirection region 431 with a selectively occlusive layer. In various implementations, the optical passthrough display does not include a selectively occlusive layer and such an approach cannot be used. In various implementations, the attention-indirection region 431 is dimmed by globally dimming a globally dimming layer and adding brightness to the attention-direction region via a light addition layer. In various circumstances, such an approach reduces the contrast and/or saturation of the attention-direction region 432.

FIG. 4D illustrates a CGR environment 400D based on the real environment 400A of FIG. 4A. The CGR environment 400D includes the sun 411, the tree 412, the rock 413, and the aerial advertisement 414. In various implementations, in order to direct a user's attention to the tree 412, the CGR environment 400D includes an attention-direction region 442 including the tree 412 and an attention-indirection region 441 away from tree 412. In FIG. 4D, the attention-indirection region 441 includes light added to the real environment 400A.

In various implementations, the CGR environment 400D is generated by a video passthrough display that captures an image of the real environment 400A with a scene camera and presents the image of the real environment 400A with light added to the attention-indirection region 441.

In various implementations, the CGR environment 400D is generated by an optical passthrough display that passes light reflected off the real environment 400A while adding light to the attention-indirection region 441. In various implementations, light is added to the attention-indirection region 441 by generating an AR image to be displayed by the light addition layer. In various implementations, the AR image does not include active pixels in the attention-direction region 442. Thus, the attention-direction region 442 is seen by the user with minimal distortion.

In various implementations, the AR image includes a masking pattern in the attention-indirection region 441 which visually masks the attention-indirection region. For example, in various implementations, the AR image includes uniform light (e.g., uniform white light or uniform colored light) in the attention-indirection region 441 to visually mask the attention-indirection region 441. As another example, in various implementations, the AR image includes noise in the attention-indirection region 441 to visually mask the attention-indirection region 441. For example, in various implementations, the AR image includes Gaussian random noise in the attention-indirection region 441. As another example, the AR image includes a periodic structure (such as lines or a grid) in the attention-indirection region 441 to visually mask the attention-indirection region 441.

Whereas, in various implementations, displaying an AR image in an attention-indirection region can be used to direct a user's direction to an attention-direction region, such as a game objection, a map destination, or an emergency vehicle, in various other implementations, displaying an AR image in an attention-indirection region can be used to direct a user's attention away from the attention-indirection region, such as an advertisement, inappropriate content, or proprietary content.

FIG. 4E illustrates a CGR environment 400E based on the real environment 400A of FIG. 4A. The CGR environment 400E includes the sun 411, the tree 412, the rock 413, and the aerial advertisement 414. In various implementations, in order to direct a user's attention away from the aerial advertisement 414, the CGR environment 400E includes an attention-indirection region 451 including the aerial advertisement 414. In FIG. 4E, the attention-indirection region 451 includes light added to the real environment 400A (e.g., an AR image).

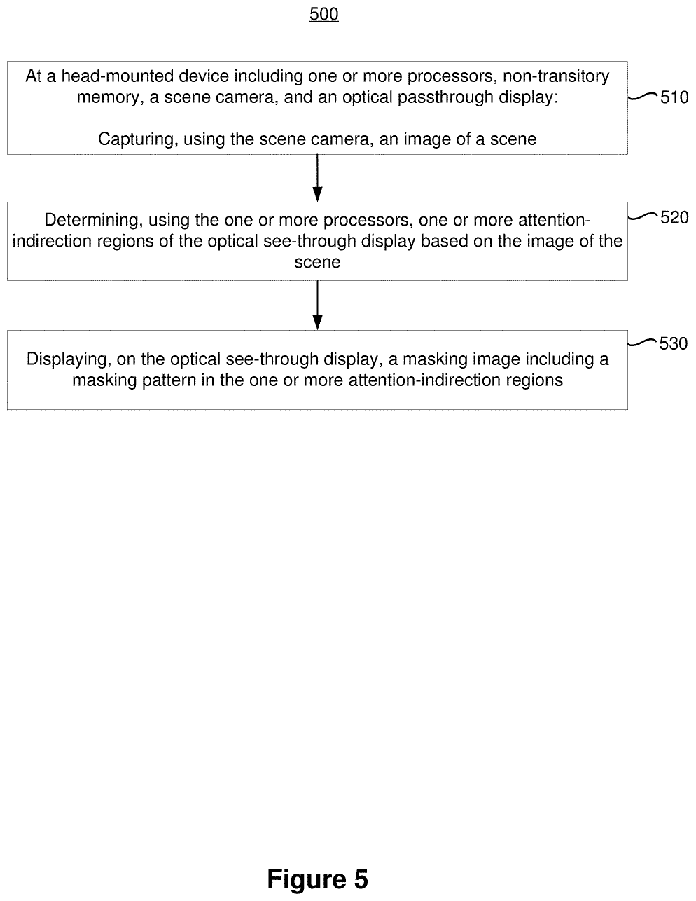

FIG. 5 is a flowchart representation of a method 500 of directing a user's attention in accordance with some implementations. In various implementations, the method 500 is performed by a device with one or more processors, non-transitory memory, a scene camera, and an optical passthrough display (e.g., the HMD 120 of FIG. 3). In some implementations, the method 500 is performed by processing logic, including hardware, firmware, software, or a combination thereof. In some implementations, the method 500 is performed by a processor executing instructions (e.g., code) stored in a non-transitory computer-readable medium (e.g., a memory).

The method 500 begins, in block 510, with the device capturing, using the scene camera, an image of a scene. For example, FIG. 4A illustrates a real environment 400A including a sun 411, a tree 412, a rock 413, and an aerial advertisement 414.

The method 500 continues, in block 520, with the device determining, using the one or more processors, one or more attention-indirection regions based on the image of the scene. In various implementations, determining the one or more attention-indirection regions includes detecting, in the image of the scene, an advertisement, inappropriate content, or proprietary content. For example, in FIG. 4E, the CGR environment 400E includes an attention-indirection region 451 including the aerial advertisement 414. In various implementations, determining the one or more attention-indirection regions includes determining one or more attention-direction regions and determining the one or more attention-indirection regions based on the one or more attention-direction regions. For example, in various implementations, determining the one or more attention-indirection regions includes selecting the entire image except for the one or more attention-direction regions. In various implementations, determining the one or more attention-direction regions includes detecting, in the image of the scene, a game objective, a map destination, or a safety issue (such as an emergency vehicle or a road hazard).

Thus, in various implementations, determining the one or more attention-indirection regions or determining the one or more attention-direction regions includes detecting an object in the image of the scene. To that end, in various implementations, various object detection and/or classification algorithms (including but not limited to shape analysis and semantic segmentation) are employed that produce a pixel set corresponding to the detected object. The attention-indirection region (or attention-direction region) is determined to encompass that pixel set.

The method 500 continues, in block 530, with the device displaying, on the optical passthrough display, a masking image including a masking pattern in the one or more attention-indirection regions. In various implementations, the device generates, using the one or more processors, the masking image including the masking pattern in the one or more attention-indirection regions. In various implementations, the masking image does not include elements outside the one or more attention-indirection regions.

In various implementations, the masking pattern in the one or more attention-indirection regions is random (or pseudorandom) noise, e.g., Gaussian noise or Poisson noise. In various implementations, the device generates the masking pattern in the one or more attention-indirection regions based on one or more masking parameters.

In various implementations, the one or more masking parameters include a spatial frequency (or spatial frequency spectrum) of the masking pattern. For example, in some embodiments, the masking pattern is noise which is spatially white noise, brown noise, or pink noise.

In various implementations, the one or more masking parameters include a temporal frequency (or temporal frequency spectrum) of the masking pattern. For example, in some embodiments, the masking pattern in the one or more attention-indirection regions does not change over time. In some embodiments, the masking pattern in the one or more attention-indirection regions changes over time at various frequencies. For example, in some embodiments, the masking pattern is noise which is temporally white noise, brown noise, or pink noise.

In various implementations, the one or more masking parameters include a locking parameter of the masking pattern indicating whether the masking image is head-locked or world-locked. For example, if the masking image is world-locked, when the user moves in the real environment, the masking image moves on the optical passthrough display such that it appears in the same location of the CGR environment. As another example, if the masking image is head-locked, when the user moves in the real environment, the masking image does not move on the optical passthrough display.

In various implementations, the one or more masking parameters include an amplitude (or luminance) of the masking pattern. In various implementations, the one or more noise parameters include a color (or chrominance) of the masking pattern. For example, in some embodiments, the masking pattern is white (e.g., the masking image includes only white pixels). In some embodiments, the masking pattern is a single color, such as red, yellow, green, blue, or purple (e.g., the masking image includes only pixels of a single color). In some embodiments, the masking pattern is multi-colored (e.g., the masking image includes pixels of different colors in different locations).

In various implementations, the device generates the masking pattern in the one or more attention-indirection regions based on the image of the scene. In various implementations, the image is classified by a classifier and a set of masking parameters corresponding to the classification are selected for generation of the masking pattern. For example, if the image is classified as a bright image, the set of masking parameters indicates a multi-colored masking pattern and if the image is classified as a dark image, the set of masking parameters indicates a white masking pattern. As another example, if the image is classified as a high contrast image, the set of masking parameters indicates a higher spatial frequency spectrum than if the image is classified as a low contrast image.

As another example, in various implementations, the device generates the masking pattern based on the image to blur, fade, or reduce contrast of the attention-indirection regions by matching the masking pattern to the image of the scene at the one or more attention-indirection regions.

In various implementations, the device generates the masking pattern in the one or more attention-indirection regions based on a gaze direction of the user. In various implementations, the device determines a gaze direction of the user using one or more eye tracking cameras directed towards one or more eyes of the user. For example, in some embodiments, the masking pattern is characterized by a first set of one or more masking parameters (e.g., stronger) in the fovea of the user (e.g., surrounding a gaze point defined by the gaze direction) and is characterized by a second set of one or more masking parameters (e.g., weaker) in the periphery of the user (surrounding the fovea). As another example, in some embodiments, the masking image includes a clear region (with minimal or no masking pattern) near the fovea of the user in the direction of an attention-direction region.

In various implementations, the device generates the masking pattern in the one or more attention-indirection regions based on a distance from an attention-direction region. For example, in some embodiments, the masking pattern is characterized by a first set of one or more masking parameters (e.g., weaker) nearer the attention-direction region and is characterized by a second set of one or more masking parameters (e.g., stronger) further from the attention-direction region. Thus, a tunnel-like effect is provided directing the user's attention to the attention-direction region.

In various implementations, the device generates the masking pattern in the one or more attention-indirection regions based on biometrics of the user. In various implementations, the masking pattern is generated based on a set of one or more masking parameters selected based on the biometrics of the user, such as a visual acuity of the user, an age of the user, or whether the user is color-blind. For example, if the visual acuity of the user is weaker (e.g., 20/200), the amplitude of the masking pattern may be increased as compared to a user with stronger visual acuity (e.g., 20/20).

In various implementations, in addition to displaying the masking image (e.g., on a light addition layer of the optical passthrough display), the device dims a globally dimmable layer of the optical passthrough display. In various implementations, the amount of dimming is proportional to a size of the one or more attention-indirection regions and an amplitude of the masking pattern. For example, in various implementations, the amount of dimming is selected to maintain the brightness of the scene in the presence of the light added by the light addition layer.

While various aspects of implementations within the scope of the appended claims are described above, it should be apparent that the various features of implementations described above may be embodied in a wide variety of forms and that any specific structure and/or function described above is merely illustrative. Based on the present disclosure one skilled in the art should appreciate that an aspect described herein may be implemented independently of any other aspects and that two or more of these aspects may be combined in various ways. For example, an apparatus may be implemented and/or a method may be practiced using any number of the aspects set forth herein. In addition, such an apparatus may be implemented and/or such a method may be practiced using other structure and/or functionality in addition to or other than one or more of the aspects set forth herein.

It will also be understood that, although the terms “first,” “second,” etc. may be used herein to describe various elements, these elements should not be limited by these terms. These terms are only used to distinguish one element from another. For example, a first node could be termed a second node, and, similarly, a second node could be termed a first node, which changing the meaning of the description, so long as all occurrences of the “first node” are renamed consistently and all occurrences of the “second node” are renamed consistently. The first node and the second node are both nodes, but they are not the same node.

The terminology used herein is for the purpose of describing particular implementations only and is not intended to be limiting of the claims. As used in the description of the implementations and the appended claims, the singular forms “a,” “an,” and “the” are intended to include the plural forms as well, unless the context clearly indicates otherwise. It will also be understood that the term “and/or” as used herein refers to and encompasses any and all possible combinations of one or more of the associated listed items. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

As used herein, the term “if” may be construed to mean “when” or “upon” or “in response to determining” or “in accordance with a determination” or “in response to detecting,” that a stated condition precedent is true, depending on the context. Similarly, the phrase “if it is determined [that a stated condition precedent is true]” or “if [a stated condition precedent is true]” or “when [a stated condition precedent is true]” may be construed to mean “upon determining” or “in response to determining” or “in accordance with a determination” or “upon detecting” or “in response to detecting” that the stated condition precedent is true, depending on the context.

What is claimed is:

1. A method comprising:
at a head-mounted device including one or more processors, non-transitory memory, a scene camera, and an optical passthrough display:
capturing, using the scene camera, an image of a scene;
determining, using the one or more processors, one or more attention-indirection regions based on the image of the scene; and
displaying, on the optical passthrough display, a masking image including a masking pattern in the one or more attention-indirection regions.

2. The method of claim 1, wherein determining the one or more attention-indirection regions includes detecting, in the image of the scene, an advertisement, inappropriate content, or proprietary content.

3. The method of claim 1, wherein determining the one or more attention-indirection regions includes determining one or more attention-direction regions and determining the one or more attention-indirection regions based on the one or more attention-direction regions.

4. The method of claim 3, wherein determining the one or more attention-direction regions includes detecting, in the image of the scene, a game objective, a map destination, or a safety issue.

5. The method of claim 1, wherein the masking image does not include elements outside the one or more attention-indirection regions.

6. The method of claim 1, wherein the masking pattern in the one or more attention-indirection regions is random noise based on one or more noise parameters.

7. The method of claim 6, wherein the one or more masking parameters includes a spatial frequency and/or a temporal frequency.

8. The method of claim 6, wherein the one or more masking parameters include a locking parameter indicating whether the noise image is head-locked or world-locked.

9. The method of claim 6, wherein the one or more masking parameters include an amplitude and/or a color of the masking pattern.

10. The method of claim 1, wherein the masking image is based on the image of the scene.

11. The method of claim 1, wherein the masking image is based on a gaze direction of a user.

12. The method of claim 1, wherein the masking image is based on biometrics of a user of the head-mounted device.

13. The method of claim 1, further comprising dimming the optical passthrough display.

14. A device comprising:
a scene camera;
an optical passthrough display;
a non-transitory memory; and
one or more processors to:
capture, using the scene camera, an image of a scene;
determine, using the one or more processors, one or more attention-indirection regions based on the image of the scene; and
display, on the optical passthrough display, a masking image including a masking pattern in the one or more attention-indirection regions.

15. The device of claim 14, wherein the optical passthrough display includes a light addition layer and the masking image is displayed by the light addition layer.

16. The device of claim 14, wherein the optical passthrough display includes a globally dimmable layer.

17. The device of claim 14, wherein optical passthrough display does not include a selectively occlusive layer.

18. The device of claim 14, wherein the masking pattern in the one or more attention-indirection regions is random noise based on one or more noise parameters.

19. The device of claim 14, wherein the masking image is based on a gaze direction of a user of the device or biometrics of the user of the device.

20. A non-transitory memory storing one or more programs, which, when executed by one or more processors of a device with a scene camera and an optical passthrough display, cause the device to:
capture, using the scene camera, an image of a scene;
determine, using the one or more processors, one or more attention-indirection regions based on the image of the scene; and
display, on the optical passthrough display, a masking image including a masking pattern in the one or more attention-indirection regions.
